(19) United States
(12) Patent Application Publication
(10) Pub. No.: US 2026/0302188 A1
(43) Pub. Date: Oct. 1, 2026

(54) CATHODE FOR LITHIUM SECONDARY BATTERY AND LITHIUM SECONDARY BATTERY INCLUDING THE SAME

(71) Applicant: SK On Co., Ltd., Seoul (KR)

(72) Inventors: Jae Ram KIM, Daejeon (KR); Ji Hee BAE, Daejeon (KR); Yeon Hwa SONG, Daejeon (KR); Jeong Seok YEON, Daejeon (KR)

(21) Appl. No.: 19/551,609

(22) Filed: Feb. 27, 2026

(30) Foreign Application Priority Data
Mar. 31, 2025 (KR) 10-2025-0041644

(51) Int. Cl. H01M 4/36; H01M 4/02; H01M 4/525; H01M 4/58; H01M 10/052

(52) U.S. Cl. CPC H01M 4/366; H01M 4/364; H01M 4/525; H01M 4/5825; H01M 10/052; H01M 2004/021; H01M 2004/028

(57) ABSTRACT

A cathode for a lithium secondary battery is disclosed. In some implementations, the cathode includes a cathode current collector and a cathode mixture layer formed on at least one surface of the cathode current collector, wherein the cathode mixture layer includes a first cathode mixture layer formed on the cathode current collector and a second cathode mixture layer formed on the first cathode mixture layer, the first cathode mixture layer includes a lithium metal phosphate, and the second cathode mixture layer includes a first lithium transition metal oxide, having a single particle form, and a second lithium transition metal oxide, having a secondary particle structure.

### CROSS-REFERENCE TO RELATED APPLICATION(S)

This patent document claims the priority and benefits of Korean Patent Application No. 10-2025-0041644 filed on Mar. 31, 2025, the disclosure of which is incorporated herein by reference in its entirety.

### TECHNICAL FIELD

The disclosure and implementations disclosed in this patent document generally relate to a cathode for a lithium secondary battery and a lithium secondary battery including the same.

### BACKGROUND

Recently, studies have been actively conducted on electric vehicles (EVs) that may replace vehicles using fossil fuels such as gasoline vehicles and diesel powered vehicles, which are among the major causes of air pollution, and lithium secondary batteries having high discharge voltage and output stability have been mainly used as power sources of such electric vehicles (EVs).

In order to improve the performance of the lithium secondary battery, it is necessary to develop technologies capable of improving the energy density, safety, and the like of a cathode for a lithium secondary battery.

### SUMMARY

According to an aspect of the present disclosure, a cathode for a lithium secondary battery having improved safety may be provided.

According to another aspect of the present disclosure, the energy density of the cathode for a lithium secondary battery may be enhanced.

According to another aspect of the present disclosure, the cycle performance of the cathode for a lithium secondary battery may be improved.

The present disclosure can be implemented in some embodiments to provide a cathode for a lithium secondary battery, the cathode including: a cathode current collector; and a cathode mixture layer formed on at least one surface of the cathode current collector, wherein the cathode mixture layer includes a first cathode mixture layer formed on the cathode current collector and a second cathode mixture layer formed on the first cathode mixture layer, the first cathode mixture layer includes a lithium metal phosphate, and the second cathode mixture layer includes a first lithium transition metal oxide, having a single particle form, and a second lithium transition metal oxide, having a secondary particle structure.

In some embodiments of the present disclosure, the lithium metal phosphate may include a lithium manganese iron phosphate (LMFP)-based active material represented by the chemical formula LiMnₓFe₁₋ₓPO₄ (0<x<1).

In some embodiments of the present disclosure, a weight of the second lithium transition metal oxide included in the second cathode mixture layer may be equal to or greater than a weight of the first lithium transition metal oxide included in the second cathode mixture layer.

In some embodiments of the present disclosure, a weight ratio of the first lithium transition metal oxide to the second lithium transition metal oxide included in the second cathode mixture layer may be 50:50 to 20:80.

In some embodiments of the present disclosure, an average particle diameter (D50) of the first lithium transition metal oxide may be 2.5 to 5 μm.

In some embodiments of the present disclosure, an average particle diameter (D50) of the second lithium transition metal oxide may be 2.5 to 13.5 μm.

In some embodiments of the present disclosure, the first lithium transition metal oxide may include nickel (Ni), and a content of nickel (Ni) may be 50 to 70 mol % based on a total content of transition metals included in the first lithium transition metal oxide.

In some embodiments of the present disclosure, the second lithium transition metal oxide may include nickel (Ni), and a content of nickel (Ni) may be 50 to 70 mol % based on a total content of transition metals included in the second lithium transition metal oxide.

In some embodiments of the present disclosure, a loading weight of the first cathode mixture layer may be equal to or greater than a loading weight of the second cathode mixture layer.

In some embodiments of the present disclosure, a loading weight ratio of the first cathode mixture layer to the second cathode mixture layer may be 50:50 to 90:10.

The present disclosure can be implemented in some embodiments to provide a lithium secondary battery including the cathode for a lithium secondary battery according to any one of the embodiments described above.

### BRIEF DESCRIPTION OF DRAWINGS

Certain aspects, features, and advantages of the present disclosure are illustrated by the following detailed description with reference to the accompanying drawings.

FIG. 1 is a conceptual cross-sectional view illustrating a cathode for a lithium secondary battery according to an embodiment.

### DETAILED DESCRIPTION

Features of the present disclosure disclosed in this patent document are described by example embodiments with reference to the accompanying drawings.

Hereinafter, the technology disclosed in the present specification and embodiments thereof will be described in detail with reference to the accompanying drawings. However, the embodiments of the technology may be modified in various other forms, and the scope thereof is not limited to the embodiments described below. In addition, the technology disclosed in the present specification may not be limited to the configurations of embodiments described below, and all or part of the embodiments may be selectively combined so that various modifications can be made.

As the demand for lithium secondary batteries increases, technologies capable of manufacturing cathodes having excellent performance are required. In this regard, in the case of a lithium nickel cobalt manganese oxide (NCM) cell in which an NCM-based active material is applied as a cathode active material, the energy density is excellent, but the safety is relatively insufficient and the cost is high.

In contrast, lithium phosphate-based active materials having an olivine structure, such as lithium iron phosphate (LFP)-based active materials, have excellent safety and cost competitiveness, but may have low lithium-ion diffusion rate and conductivity due to their structural characteristics. Accordingly, an LFP cell to which the LFP-based active material is applied has disadvantages in that its energy density and low-temperature performance are insufficient.

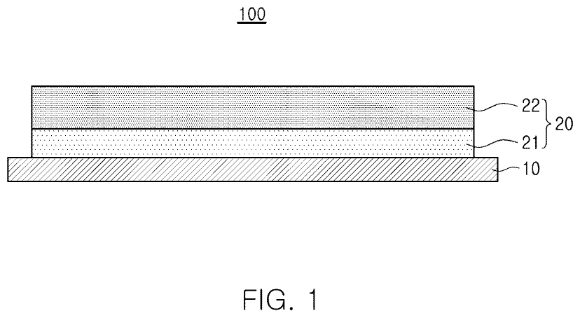

The present disclosure can be implemented in some embodiments to provide a cathode for a lithium secondary battery that alleviates the above-described problems and has excellent energy density, safety, cycle performance, and cost competitiveness. Hereinafter, embodiments of the present disclosure will be described in detail with reference to FIG. 1.

FIG. 1 is a conceptual cross-sectional view illustrating a cathode for a lithium secondary battery according to an embodiment.

### Cathode for Lithium Secondary Battery

A cathode 100 for a lithium secondary battery according to an embodiment includes a cathode current collector 10 and a cathode mixture layer 20 formed on at least one surface of the cathode current collector, wherein the cathode mixture layer includes a first cathode mixture layer 21 formed on the cathode current collector and a second cathode mixture layer 22 formed on the first cathode mixture layer, the first cathode mixture layer includes a lithium metal phosphate, and the second cathode mixture layer includes a first lithium transition metal oxide, having a single particle form, and a second lithium transition metal oxide, having a secondary particle structure.

The material of the cathode current collector 10 is not particularly limited. For example, the cathode current collector may be a plate or a foil formed of one or more selected from indium (In), copper (Cu), magnesium (Mg), stainless steel, titanium (Ti), iron (Fe), cobalt (Co), nickel (Ni), zinc (Zn), aluminum (Al), germanium (Ge), lithium (Li), and alloys thereof. In some embodiments of the present disclosure, the cathode current collector may be an aluminum foil (Al foil).

The thickness of the cathode current collector 10 is not particularly limited. For example, the thickness of the cathode current collector may be 0.1 to 50 μm.

The cathode mixture layer 20 may include a mixture of a lithium transition metal oxide and a lithium metal phosphate as a cathode active material. Specifically, the cathode mixture layer 20 may include the first cathode mixture layer 21 formed on the cathode current collector 10 and the second cathode mixture layer 22 formed on the first cathode mixture layer, the first cathode mixture layer 21 may include a lithium metal phosphate, and the second cathode mixture layer 22 may include a lithium transition metal oxide. In this case, the respective active materials may secure their advantages while complementing respective disadvantages thereof, thereby contributing to improving the performance of the cell.

The lithium transition metal oxide may include an active material such as lithium nickel cobalt manganese oxide (NCM), which has excellent energy density, and the lithium metal phosphate may include an active material such as lithium iron phosphate (LFP), which has an olivine structure having excellent structural stability.

In some embodiments of the present disclosure, the lithium metal phosphate may be represented by Chemical Formula 1 below:

LiMePO₄ [Chemical Formula 1]

wherein Me is at least one element selected from the group consisting of Co, Ni, Fe, and Mn.

The lithium metal phosphate represented by Chemical Formula 1 may be lithium metal oxide particles having an olivine structure having excellent structural stability. For example, the lithium metal phosphate may include a lithium iron phosphate (LFP)-based active material containing iron (Fe).

In some embodiments of the present disclosure, the lithium metal phosphate may include a lithium manganese iron phosphate (LMFP)-based active material represented by the chemical formula LiMnₓFe₁₋ₓPO₄ (0<x<1). Specifically, in the chemical formula, x may satisfy 0.5≤x≤0.7. The LMFP-based active material may be an active material in which iron (Fe) in an LFP-based active material is partially substituted with manganese (Mn), and may have relatively excellent energy density and low-temperature performance compared to the LFP-based active material. Accordingly, when the cathode 100 for a lithium secondary battery includes an LMFP-based active material, a lithium secondary battery having high energy density may be provided. According to an embodiment, the lithium metal phosphate may further include an LFP-based active material in addition to the LMFP-based active material.

The particle composition of the lithium metal phosphate may be identified by inductively coupled plasma (ICP) analysis. For example, the particles of the lithium metal phosphate may be analyzed by ICP, and the number of phosphorus atoms may be normalized to one, thereby obtaining a chemical formula.

The second cathode mixture layer 22 may include, as lithium transition metal oxides, a first lithium transition metal oxide, having a single particle form, and a second lithium transition metal oxide, having a secondary particle structure. Specifically, the first lithium transition metal oxide may be a primary particle composed of a single crystal, and the second lithium transition metal oxide may have a secondary particle structure in which a plurality of primary particles are assembled or aggregated.

When the second cathode mixture layer includes a mixture of a lithium transition metal oxide, having a single particle form, and a lithium transition metal oxide, having a secondary particle structure, both the capacity and safety of the lithium secondary battery may be improved.

The term “single particle form” as used in the present specification may be used to exclude, for example, secondary particles formed by the aggregation of a plurality of primary particles. For example, in the first lithium transition metal oxide, a secondary particle structure in which primary particles (for example, more than 10, 20 or more, 30 or more, 40 or more, 50 or more, or the like) are assembled or aggregated may be excluded.

In addition, the term “secondary particle structure” as used in the present specification may, for example, refer to secondary particles formed by the aggregation of a plurality of primary particles. For example, the second lithium transition metal oxide may have a secondary particle structure in which more than 10, 20 or more, 30 or more, 40 or more, or 50 or more primary particles are assembled or aggregated.

Meanwhile, the term “single particle form” as used in the present specification does not exclude, for example, cases in which single particles in a range of 2 to 10 are not assembled or aggregated but merely attached or in contact with one another to have a single-body form.

Whether the lithium transition metal oxide has a single particle form or a secondary particle structure may be determined based on an ion image obtained by analyzing a cross-section of the active material particles using a focused ion beam (FIB). For example, when the active material particle has a secondary particle structure, the particle may be observed as a single particle in an SEM cross-sectional image, but may be observed as a particle in which two or more single crystals constitute two or more crystals, depending on differences in crystal orientation in an FIB analysis image. Accordingly, cases in which two or more single crystals are not observed due to differences in crystal orientation in the FIB analysis image may be determined as cases where the active material particle has a single particle form.

In some embodiments of the present disclosure, a weight of the second lithium transition metal oxide included in the second cathode mixture layer 22 may be equal to or greater than a weight of the first lithium transition metal oxide included in the second cathode mixture layer. When the weight of the second lithium transition metal oxide, having a secondary particle structure, included in the second cathode mixture layer 22 is greater than the weight of the first lithium transition metal oxide, having a single particle form, the capacity of the cathode and the lithium secondary battery including the same may be further improved.

Specifically, a weight ratio of the first lithium transition metal oxide to the second lithium transition metal oxide included in the second cathode mixture layer 22 may be 50:50 to 20:80. More specifically, in the second cathode mixture layer 22, the second lithium transition metal oxide may be included in an amount of 50 parts by weight or more, 60 parts by weight or more, or 70 parts by weight or more, and 80 parts by weight or less, based on 100 parts by total weight of the first lithium transition metal oxide and the second lithium transition metal oxide.

In some embodiments of the present disclosure, an average particle diameter (D50) of the lithium metal phosphate may be equal to or less than an average particle diameter (D50) of the first lithium transition metal oxide and the second lithium transition metal oxide. Because lithium metal phosphate having an olivine structure exhibits a relatively low energy density due to its material characteristics, when the particle size of the lithium metal phosphate is controlled to be relatively small, the energy density of a cathode and a lithium secondary battery including lithium metal phosphate particles having a relatively low capacity may be improved, and the diffusion rate of lithium ions may be enhanced.

In some embodiments of the present disclosure, the average particle diameter (D50) of the lithium metal phosphate may be 0.5 μm to 1.5 μm. Specifically, the average particle diameter (D50) of the lithium metal phosphate particles may be 0.6 μm or more or 0.8 μm or more, and may be 1.2 μm or less or 1.0 μm or less.

In some embodiments of the present disclosure, an average particle diameter (D50) of the first lithium transition metal oxide may be 2.5 to 5 μm. Specifically, the average particle diameter (D50) of the first lithium transition metal oxide particles may be 3.3 μm or more or 3.6 μm or more, and may be 4.5 μm or less or 4 μm or less.

In some embodiments of the present disclosure, an average particle diameter (D50) of the second lithium transition metal oxide may be 2.5 to 13.5 μm. Specifically, the average particle diameter (D50) of the second lithium transition metal oxide particles may be 5 μm or more, 8.5 μm or more, or 12 μm or more, and may be 13 μm or less.

In the present specification, the average particle diameter (D50) may be a particle diameter value at a cumulative volume fraction of 50% from the smallest particle in a particle size distribution measured in accordance with ISO-13320 using a particle size analyzer (SYNC manufactured by Microtrac Retsch GmbH) based on a laser diffraction method.

In some embodiments of the present disclosure, at least one of the first lithium transition metal oxide and the second lithium transition metal oxide may include a layered structure or a crystal structure represented by Chemical Formula 2 below:

LiₓNiₐCo_{b1}Mn_{b2}O_{2+z} [Chemical Formula 2]

wherein 0.9≤x≤1.2, 0.6≤a≤0.99, 0.01≤b1+b2≤0.4, and −0.5≤z≤0.1.

The chemical structure represented by Chemical Formula 2 indicates bonding relationships included in the layered structure or crystal structure of the cathode active material, and the Ni, Co, and Mn may be provided as main active elements of the cathode active material. That is, the chemical structure represented by Chemical Formula 2 is provided to express bonding relationships of the main active elements, and does not exclude the presence of other additional elements. Accordingly, Chemical Formula 2 should be understood as encompassing introduction and substitution of additional elements.

In some embodiments of the present disclosure, auxiliary elements for enhancing the chemical stability of the cathode active material or the layered structure/crystal structure may be further included in addition to the main active elements. The auxiliary elements may be incorporated together into the layered structure/crystal structure to form bonds, and such a case should also be understood as being included within the scope of the chemical structure represented by Chemical Formula 2.

The auxiliary element may include, for example, at least one selected from Na, Mg, Ca, Y, Ti, Hf, V, Nb, Ta, Cr, Mo, W, Fe, Cu, Ag, Zn, B, Al, Ga, C, Si, Sn, Sr, Ba, Ra, P, and Zr. For example, the auxiliary element may act as an auxiliary active element contributing to capacity and output activity of the cathode active material together with Co or Mn, such as Al.

In some embodiments of the present disclosure, the cathode active material may further include a coating material or a doping material containing a coating element or a doping element. For example, elements that are substantially the same as or similar to the auxiliary elements described above may be used as coating elements or doping elements. For example, the auxiliary elements described above may be used alone or in combination of two or more thereof as coating elements or doping elements. In this case, by adjusting the upper operating voltage of the lithium secondary battery, voltage decay of the lithium secondary battery may be suppressed.

The coating element or the doping element may be present on the particle surface of the cathode active material, or may penetrate through the particle surface of the cathode active material to be included in the bonding structure represented by Chemical Formula 2.

In some embodiments of the present disclosure, the coating element may form a sea-type coating layer or an island-type coating layer.

In some embodiments of the present disclosure, a content of the coating element in the particles of the cathode active material may be 500 to 8,000 ppm, 1,000 to 8,000 ppm, or 1,500 to 8,000 ppm based on a total weight of all elements excluding lithium and oxygen. When the content of the coating element is as described above, an initial capacity reduction and an increase in resistance of the lithium secondary battery may be prevented, and voltage decay of the lithium secondary battery may be further suppressed.

In some embodiments of the present disclosure, the coating material may be formed according to a dry coating method or a wet coating method. For example, the particles of the cathode active material and a coating source may be dry-mixed or wet-mixed and then subjected to heat treatment (for example, calcination or drying) to form a coating material on the particle surface of the cathode active material. A coating source known in the art may be used as the coating source. For example, the coating source may contain B, Al, W, Zr, Ti, Mg, Co, and the like.

In some embodiments of the present disclosure, the first lithium transition metal oxide may include nickel (Ni), and a content of nickel (Ni) may be 50 to 70 mol % based on a total content of transition metals included in the first lithium transition metal oxide. Specifically, the content of nickel (Ni) may be 55 mol % or more and may be 65 mol % or less, based on the total content of transition metals included in the first lithium transition metal oxide.

In some embodiments of the present disclosure, the second lithium transition metal oxide may include nickel (Ni), and a content of nickel (Ni) may be 50 to 70 mol % based on a total content of transition metals included in the second lithium transition metal oxide. Specifically, the content of nickel (Ni) may be 55 mol % or more and may be 65 mol % or less, based on the total content of transition metals included in the second lithium transition metal oxide.

When the first lithium transition metal oxide and the second lithium transition metal oxide each include nickel (Ni) and correspond to a mid-Ni active material having a content of 50 to 70 mol %, thermal stability of the cathode may be improved, thereby reducing gas generation in the lithium secondary battery and enhancing safety.

The particle composition of the lithium transition metal oxide may be identified by inductively coupled plasma (ICP) analysis. For example, the particles of the cathode active material may be analyzed by ICP, and the number of oxygen atoms may be normalized to 1.8 to 2.2 (for example, 2), thereby obtaining a chemical formula of the cathode active material.

In some embodiments of the present disclosure, a loading weight of the first cathode mixture layer 21 may be equal to or greater than a loading weight of the second cathode mixture layer 22. Specifically, in the cathode 100 for a lithium secondary battery, the loading weight of the first cathode mixture layer 21 including a lithium metal phosphate may be equal to or greater than the loading weight of the second cathode mixture layer 22 including a lithium transition metal oxide. In this case, capacity of the cathode and the lithium secondary battery may be improved while ensuring safety.

In some embodiments of the present disclosure, a loading weight ratio of the first cathode mixture layer 21 to the second cathode mixture layer 22 may be 50:50 to 90:10. Specifically, a loading weight ratio of the first cathode mixture layer 21 may be 50% or more or 70% or more, and may be 90% or less or 80% or less, based on a total loading weight of the cathode mixture layer 20. In addition, a loading weight ratio of the second cathode mixture layer 22 may be 10% or more or 20% or more, and may be 50% or less or 30% or less, based on the total loading weight of the cathode mixture layer 20.

In some embodiments of the present disclosure, each of the first cathode mixture layer 21 and the second cathode mixture layer 22 may further include a binder. The binder is not particularly limited. For example, the binder may include one or two or more selected from polyvinylidene fluoride (PVDF), styrene-butadiene rubber (SBR), polytetrafluoroethylene, polyvinylidene fluoride/hexafluoropropylene copolymer, polyacrylonitrile, and polymethyl methacrylate.

In some embodiments of the present disclosure, a content of the binder included in the first cathode mixture layer 21 may be equal to or greater than a content of the binder included in the second cathode mixture layer 22. Specifically, a weight percentage of the binder included in the first cathode mixture layer based on a total weight of the first cathode mixture layer 21 may be equal to or greater than a weight percentage of the binder included in the second cathode mixture layer based on a total weight of the second cathode mixture layer 22. In this case, while improving energy density of the cathode by reducing the content of the binder based on the entire cathode mixture layer 20, adhesion between the cathode current collector 10 and the cathode mixture layer 20 may be secured.

In some embodiments of the present disclosure, the content of the binder included in the first cathode mixture layer 21 may be 0.5 wt % or more, 1.0 wt % or more, or 1.5 wt % or more, and may be 6.0 wt % or less, 4.0 wt % or less, or 2.0 wt % or less.

In some embodiments of the present disclosure, the content of the binder included in the second cathode mixture layer 22 may be 0.1 wt % or more, 0.5 wt % or more, or 0.8 wt % or more, and may be 4.0 wt % or less, 2.0 wt % or less, or 1.0 wt % or less.

In some embodiments of the present disclosure, each of the first cathode mixture layer 21 and the second cathode mixture layer 22 may further include a conductive material. The conductive material is not particularly limited. In some embodiments of the present disclosure, the conductive material may include at least one of a needle-type conductive material and a sphere-type conductive material.

In the present specification, the needle-type conductive material may refer to a conductive material having an elliptical particle shape and having a relatively large aspect ratio (a ratio of length to diameter). For example, an aspect ratio of the needle-type conductive material may be 2 or more, 10 or more, 50 or more, or 100 or more, and may be 10,000 or less, 5,000 or less, 3,000 or less, or 1,000 or less.

For example, the needle-type conductive material may include at least one selected from conductive fibers such as carbon fibers and metal fibers; conductive tubes such as carbon nanotubes (CNTs), including single-walled carbon nanotubes (SWCNTs) and multi-walled carbon nanotubes (MWCNTs); fluorocarbon; metal powders such as aluminum, and nickel powders; conductive whiskers such as zinc oxide and potassium titanate; conductive metal oxides such as titanium oxide; and conductive materials such as polyphenylene derivatives. In some embodiments of the present disclosure, the needle-type conductive material may include carbon nanotubes (CNTs).

When the cathode 100 for a lithium secondary battery includes the needle-type conductive material described above, passage of lithium ions through the cathode mixture layer 20 may be facilitated, thereby improving lithium-ion conductivity and reducing resistance of the cathode and the battery.

In some embodiments of the present disclosure, a content of the needle-type conductive material included in the first cathode mixture layer 21 may be 0.1 wt % to 1.0 wt %. Specifically, the content of the needle-type conductive material included in the first cathode mixture layer 21 may be 0.3 wt % or more or 0.5 wt % or more, and may be 0.9 wt % or less or 0.7 wt % or less. In addition, a content of the needle-type conductive material included in the second cathode mixture layer 22 may be 0.1 wt % to 1.0 wt %. Specifically, the content of the needle-type conductive material included in the second cathode mixture layer 22 may be 0.3 wt % or more or 0.5 wt % or more, and may be 0.9 wt % or less or 0.7 wt % or less.

In some embodiments of the present disclosure, the cathode mixture layer 20 may further include a sphere-type conductive material. In the present specification, the sphere-type conductive material may refer to a conductive material having a spherical particle shape and having a relatively small aspect ratio (a ratio of length to diameter). For example, the aspect ratio of the sphere-type conductive material may be 0.5 to 1.5. In some embodiments of the present disclosure, an average particle diameter (D50) of the sphere-type conductive material may be 100 nm or less. Specifically, the average particle diameter (D50) of the sphere-type conductive material may be 20 nm or more and may be 70 nm or less.

For example, the sphere-type conductive material may include at least one selected from graphite such as natural graphite and artificial graphite; and carbon black such as acetylene black, Ketjen black, channel black, furnace black, lamp black, and thermal black. In some embodiments of the present disclosure, the sphere-type conductive material may include carbon black.

In some embodiments of the present disclosure, a content of the sphere-type conductive material included in the first cathode mixture layer 21 may be 0.1 wt % to 1.0 wt %. In addition, a content of the sphere-type conductive material included in the second cathode mixture layer 22 may be 0.1 wt % to 1.0 wt %.

In some embodiments of the present disclosure, a total content of the conductive material included in the first cathode mixture layer 21 may be 0.2 wt % to 2.0 wt %. In addition, a total content of the conductive material included in the second cathode mixture layer 22 may be 0.2 wt % to 2.0 wt %.

The cathode 100 for a lithium secondary battery according to any one of the embodiments described above may be manufactured by the following method.

### Method for Manufacturing Cathode for Lithium Secondary Battery

A method for manufacturing the cathode 100 for a lithium secondary battery according to an embodiment may include forming a cathode mixture layer 20 on at least one surface of a cathode current collector 10. The cathode mixture layer may include a first cathode mixture layer 21 formed on the cathode current collector and a second cathode mixture layer 22 formed on the first cathode mixture layer. The first cathode mixture layer may include a lithium metal phosphate, and the second cathode mixture layer may include a first lithium transition metal oxide, having a single particle form, and a second lithium transition metal oxide, having a secondary particle structure. A detailed description of the lithium metal phosphate and the like is omitted because the content overlaps with the above description.

The first cathode mixture layer 21 may be manufactured by a first cathode slurry including a lithium metal phosphate, and the second cathode mixture layer 22 may be manufactured by a second cathode slurry including a first lithium transition metal oxide, having a single particle form, and a second lithium transition metal oxide, having a secondary particle structure.

In some embodiments of the present disclosure, each of the first cathode slurry and the second cathode slurry may further include a solvent. The solvent is not particularly limited. For example, the solvent may be N-methyl-2-pyrrolidone (NMP).

In some embodiments of the present disclosure, each of the first cathode slurry and the second cathode slurry may further include a conductive material. A detailed description of the conductive material is omitted because the content overlaps with the above description.

In some embodiments of the present disclosure, each of the first cathode slurry and the second cathode slurry may further include a binder. A detailed description of the binder is omitted because the content overlaps with the above description.

In some embodiments of the present disclosure, the cathode mixture layer 20 may be formed by applying the first cathode slurry and the second cathode slurry respectively onto at least one surface of the cathode current collector 10 and then performing drying. In this case, the first cathode mixture layer 21 and the second cathode mixture layer 22 may be formed simultaneously (that is, the first cathode slurry and the second cathode slurry are applied simultaneously), or the second cathode mixture layer 22 may be formed after the first cathode mixture layer 21 is formed (that is, the first cathode slurry is applied first and dried to form the first cathode mixture layer 21, and then the second cathode slurry is applied).

The method of applying the cathode slurry is not particularly limited. For example, the cathode slurry may be applied by bar coating, casting, or spraying.

In some embodiments of the present disclosure, the drying of the cathode slurry may be performed at 100 to 200° C. For example, the drying of the cathode slurry may be performed at 130 to 170° C.

### Lithium Secondary Battery

A lithium secondary battery according to an embodiment includes the cathode 100 for a lithium secondary battery according to any one of the embodiments described above. For example, the lithium secondary battery may include a unit cell including the cathode for a lithium secondary battery described above, an anode, and a separator. The separator may be disposed between the cathode and the anode in the unit cell.

The anode is not particularly limited. For example, the anode may include an anode current collector and an anode mixture layer formed on at least one surface of the anode current collector.

The material of the anode current collector is not particularly limited. For example, the anode current collector may be a plate or a foil formed of one or more selected from indium (In), copper (Cu), magnesium (Mg), stainless steel, titanium (Ti), iron (Fe), cobalt (Co), nickel (Ni), zinc (Zn), aluminum (Al), germanium (Ge), lithium (Li), and alloys thereof. In some embodiments of the present disclosure, the anode current collector may be a copper foil (Cu foil).

The thickness of the anode current collector is not particularly limited. For example, the thickness of the anode current collector may be 0.1 to 50 μm.

The anode mixture layer may include an anode active material. The anode active material is not particularly limited. For example, the anode active material may be one or more selected from the group consisting of carbon-based materials such as crystalline carbon, amorphous carbon, carbon composites, and carbon fibers; lithium metal; lithium alloys; silicon-containing materials; and tin-containing materials.

The crystalline carbon may be, for example, graphite-based carbon such as natural graphite, artificial graphite, graphitized coke, graphitized mesocarbon microbeads (MCMBs), or graphitized mesophase pitch-based carbon fibers (MPCFs).

The amorphous carbon may be, for example, hard carbon, soft carbon, coke, mesocarbon microbeads (MCMBs), or mesophase pitch-based carbon fibers (MPCFs).

The elements included in the lithium alloy may be, for example, aluminum, zinc, bismuth, cadmium, antimony, silicon, lead, tin, gallium, or indium.

The silicon-containing material is not particularly limited as long as it contains silicon and may be an active material capable of alloying with lithium (Li). For example, the silicon-containing material may be one or more selected from the group consisting of silicon (Si), silicon oxide (SiOx; 0<x<2), metal-doped silicon oxide (SiOx; 0<x<2), carbon-coated silicon oxide (SiOx; 0<x<2), silicon-carbon composites (Si—C), and silicon alloys.

The anode mixture layer may further include a binder. The binder is not particularly limited. For example, the binder may be any one of a rubber-based binder such as styrene-butadiene rubber (SBR), a fluorine-based rubber, ethylene-propylene rubber, butadiene rubber, isoprene rubber, or a silane-based rubber; a cellulose-based binder such as carboxymethyl cellulose (CMC), hydroxypropyl methylcellulose, methylcellulose, or an alkali metal salt thereof; and combinations thereof.

The anode mixture layer may further include a conductive material. The conductive material is not particularly limited. For example, the conductive material may be one or more selected from particulate carbon materials and fibrous carbon materials. The particulate carbon materials may be carbon black such as Super-P and Super-C, acetylene black, and Ketjen black, and the fibrous carbon materials may be carbon fibers, carbon nanotubes (CNTs), and vapor grown carbon fibers (VGCFs).

The separator is not particularly limited. For example, the separator may include a porous polymer film manufactured from a polyolefin-based polymer such as an ethylene homopolymer, a propylene homopolymer, an ethylene/butene copolymer, an ethylene/hexene copolymer, or an ethylene/methacrylate copolymer. In addition, the separator may further include a nonwoven fabric formed of high-melting point glass fibers, polyethylene terephthalate fibers, or the like.

In some embodiments of the present disclosure, the lithium secondary battery may be manufactured by housing the unit cell described above in a pouch serving as a battery case and then injecting an electrolyte.

The electrolyte may include an organic solvent and a lithium salt. The organic solvent functions as a medium through which ions involved in electrochemical reactions of the battery may move. For example, one or a combination of two or more selected from carbonate-based solvents, ester-based solvents, ether-based solvents, ketone-based solvents, alcohol-based solvents, and aprotic solvents may be used, and when two or more of these solvents are used in combination, a mixing ratio thereof may be appropriately adjusted depending on desired battery performance.

The lithium salt is dissolved in the organic solvent and serves as a source of lithium ions in the battery, enables basic operation of the lithium secondary battery, and promotes movement of lithium ions between the cathode and the anode. As the lithium salt, a known material may be used at a concentration suitable for the intended purpose. The electrolyte may further include a known solvent to improve, as needed, charge/discharge characteristics, flame-retardant characteristics, or the like, and may include a known additive.

In some embodiments of the present disclosure, the unit cell may not include a separator between the cathode and the anode and may include a solid electrolyte. The solid electrolyte is not particularly limited. For example, the solid electrolyte may be an oxide-based solid electrolyte, a sulfide-based solid electrolyte, or a polymer-based solid electrolyte.

### EXAMPLES

### 1. Manufacture of Cathode and Secondary Battery

### 1) Manufacture of Cathode for Lithium Secondary Battery

### (1) Example 1

An LMFP-based active material having an average particle diameter (D50) of 0.87 μm and represented by the chemical formula LiMnₓFe₁₋ₓPO₄ (0.5≤x≤0.7) was prepared as a lithium metal phosphate. An NCM-based active material with a single particle form having an average particle diameter (D50) of 3.8 μm and represented by the chemical formula LiNi_{0.6}Co_{0.1}Mn_{0.3}O₂ was prepared as a first lithium transition metal oxide. An NCM-based active material with a secondary particle structure having an average particle diameter (D50) of 12.9 μm and represented by the chemical formula LiNi_{0.6}Co_{0.2}Mn_{0.2}O₂ was prepared as a second lithium transition metal oxide. Polyvinylidene fluoride (PVDF) was prepared as a binder. Multi-walled carbon nanotubes (MWCNTs) as a needle-type conductive material and carbon black as a sphere-type conductive material were prepared as conductive materials.

98 wt % of the lithium metal phosphate, 1.4 wt % of the binder, and 0.6 wt % of the needle-type conductive material were mixed with a solvent (NMP) based on the solid content, thereby preparing a first cathode slurry. In addition, 24.525 wt % of the first lithium transition metal oxide, 73.575 wt % of the second lithium transition metal oxide, 0.9 wt % of the binder, 0.6 wt % of the needle-type conductive material, and 0.4 wt % of the sphere-type conductive material were mixed with a solvent (NMP) based on the solid content, thereby preparing a second cathode slurry.

The cathode slurries (the first cathode slurry and the second cathode slurry applied on the first cathode slurry) were simultaneously applied onto one surface of a cathode current collector (Al foil) having a thickness of 12 μm at a total loading weight of 20 mg/cm², and then performing drying and rolling, thereby manufacturing a cathode of Example 1 having an electrode thickness (including the current collector) of 155 μm and an electrode density of 2.8 g/cc. In the finally manufactured cathode, the weight ratio of the first lithium transition metal oxide to the second lithium transition metal oxide included in the upper layer (the second cathode mixture layer) was 25:75, and the loading weight ratio of the first cathode mixture layer to the second cathode mixture layer was 75:25.

### (2) Example 2

A cathode of Example 2 was manufactured in the same manner as in Example 1, except that, in the finally manufactured cathode, the weight ratio of the first lithium transition metal oxide to the second lithium transition metal oxide included in the upper layer (the second cathode mixture layer) was adjusted to 50:50.

### (3) Example 3

A cathode of Example 3 was manufactured in the same manner as in Example 1, except that, in the finally manufactured cathode, the content of the first lithium transition metal oxide included in the upper layer (the second cathode mixture layer) was greater than the content of the second lithium transition metal oxide. Specifically, in the cathode of Example 3, the weight ratio of the first lithium transition metal oxide to the second lithium transition metal oxide included in the upper layer (the second cathode mixture layer) was 75:25.

### (4) Example 4

A cathode of Example 4 was manufactured in the same manner as in Example 1, except that an NCM-based active material with a single particle form having an average particle diameter (D50) greater than 10 μm (10.5 μm) and represented by the chemical formula LiNi_{0.6}Co_{0.1}Mn_{0.3}O₂ was used as the first lithium transition metal oxide.

### (5) Example 5

A cathode of Example 5 was manufactured in the same manner as in Example 1, except that an NCM-based active material with a single particle form having a nickel (Ni) content greater than 70 mol % and represented by the chemical formula LiNi_{0.9}Co_{0.05}Mn_{0.05}O₂ was used as the first lithium transition metal oxide.

### (6) Example 6

A cathode of Example 6 was manufactured in the same manner as in Example 1, except that an NCM-based active material with a secondary particle structure having a nickel (Ni) content greater than 70 mol % and represented by the chemical formula LiNi_{0.9}Co_{0.05}Mn_{0.05}O₂ was used as the second lithium transition metal oxide.

### (7) Example 7

A cathode of Example 7 was manufactured in the same manner as in Example 1, except that, in the finally manufactured cathode, the loading weight ratio of the first cathode mixture layer to the second cathode mixture layer was adjusted to 25:75.

### (8) Comparative Example 1

A cathode of Comparative Example 1 was manufactured in the same manner as in Example 1, except that the upper layer (the second cathode mixture layer) included, as a cathode active material, only an NCM-based active material with a single particle form (the first lithium transition metal oxide) having an average particle diameter (D50) of 3.8 μm and represented by the chemical formula LiNi_{0.6}Co_{0.1}Mn_{0.3}O₂.

### (9) Comparative Example 2

A cathode of Comparative Example 2 was manufactured in the same manner as in Example 1, except that the upper layer (the second cathode mixture layer) included, as a cathode active material, only an NCM-based active material with a secondary particle structure (the second lithium transition metal oxide) having an average particle diameter (D50) of 12.9 μm and represented by the chemical formula LiNi_{0.6}Co_{0.2}Mn_{0.2}O₂.

### 2) Manufacture of Secondary Battery

### (1) Half-Cell

A coin-type half-cell lithium secondary battery sample including the cathode manufactured as described above was manufactured. Specifically, a circular cathode punched to a diameter of 14 mm, a polyolefin separator, and lithium metal were sequentially placed on a lower case of a coin cell. Thereafter, an electrolyte (obtained by dissolving 1 M LiPF₆ in a mixed solvent of ethylene carbonate (EC) and diethyl carbonate (DEC)) was injected, and an upper case was covered to manufacture a coin-type half-cell.

### (2) Full-Cell

A full-cell-type lithium secondary battery sample including the cathode manufactured as described above was manufactured. Specifically, an anode slurry including an anode active material (artificial graphite and natural graphite) was applied onto a copper foil (Cu foil) having a thickness of 6 μm and dried, thereby manufacturing an anode for a lithium secondary battery. Thereafter, a secondary battery cell manufactured by interposing a polyolefin separator between the cathode and the anode manufactured as described above was placed into a battery case, an electrolyte obtained by dissolving 1 M LiPF₆ in a mixed solvent of ethylene carbonate (EC) and diethyl carbonate (DEC) was injected into the battery case, and then, the battery case was sealed, thereby manufacturing a lithium secondary battery.

### 2. Evaluation of Secondary Battery

### 1) Discharge Capacity of Coin Cells

The discharge capacities of the manufactured half-cell-type lithium secondary battery samples were measured, and the results are shown in Table 1. Specifically, the discharge capacity of each secondary battery sample was measured in units of mAh/g by charging the sample under CC/CV conditions at 0.1 C and 4.4 V with a cut-off current of 0.05 C at 25° C., allowing the sample to stand for 10 minutes, and discharging the sample under CC conditions at 0.1 C to a cut-off voltage of 3.0 V.

2) Gas Generation after storage at 60° C.

The results of evaluating the gas generation of the manufactured full-cell-type lithium secondary battery samples after storage at 60° C. for 4 weeks are shown in Table 1. Specifically, in each secondary battery sample, the portion of the swollen pouch area within the electrode tab area was measured, and a value of 70% or more was evaluated as “Large”, a value of 30% to 70% was evaluated as “Medium”, and a value of 30% or less was evaluated as “Small”.

TABLE 1

| | | | | | | Gas |
|---|---|---|---|---|---|---|
| | | | | | | generation |
| | | | | Type and | Coin-cell | after |
| | | LW ratio | | weight ratio | discharge | storage at |
| | Electrode | of upper/ | | of active | capacity | 60 °C |
| | structure | lower layers | | materials | (mAh/g) | (4 weeks) |
| Example 1 | Dual- | Upper | 25 | First lithium | 161 | Small |
| | Layer | layer | | transition metal | | |
| | | | | oxide (NCM 613 | | |
| | | | | single | | |
| | | | | particle):second | | |
| | | | | lithium transition | | |
| | | | | metal oxide (NCM | | |
| | | | | 622 secondary | | |
| | | | | particle) = 25:75 | | |
| | | Lower | 75 | LMFP | | |
| | | layer | | | | |
| Example 2 | Dual- | Upper | 25 | First lithium | 161 | Small |
| | Layer | layer | | transition metal | | |
| | | | | oxide (NCM 613 | | |
| | | | | single | | |
| | | | | particle):second | | |
| | | | | lithium transition | | |
| | | | | metal oxide (NCM | | |
| | | | | 622 secondary | | |
| | | | | particle) = 50:50 | | |
| | | Lower | 75 | LMFP | | |
| | | layer | | | | |
| Example 3 | Dual- | Upper | 25 | First lithium | 159.7 | Small |
| | Layer | layer | | transition metal | | |
| | | | | oxide (NCM 613 | | |
| | | | | single | | |
| | | | | particle):second | | |
| | | | | lithium transition | | |
| | | | | metal oxide (NCM | | |
| | | | | 622 secondary | | |
| | | | | particle) = 75:25 | | |
| | | | | (content of single | | |
| | | | | particles > | | |
| | | | | content of | | |
| | | | | secondary | | |
| | | | | particles ) | | |
| | | Lower | 75 | LMFP | | |
| | | layer | | | | |
| Example 4 | Dual- | Upper | 25 | First lithium | 159.5 | Small |
| | Layer | layer | | transition metal | | |
| | | | | oxide (NCM 613 | | |
| | | | | single | | |
| | | | | particle):second | | |
| | | | | lithium transition | | |
| | | | | metal oxide (NCM | | |
| | | | | 622 secondary | | |
| | | | | particle) = 25:75 | | |
| | | | | (D50 of single | | |
| | | | | particle exceeds | | |
| | | | | 10 μm) | | |
| | | Lower | 75 | LMFP | | |
| | | layer | | | | |
| Example 5 | Dual- | Upper | 25 | First lithium | 160 | Medium |
| | Layer | layer | | transition metal | | |
| | | | | oxide (NCM | | |
| | | | | 9½½ single | | |
| | | | | particle):second | | |
| | | | | lithium transition | | |
| | | | | metal oxide (NCM | | |
| | | | | 622 secondary | | |
| | | | | particle) = 25:75 | | |
| | | Lower | 75 | LMFP | | |
| | | layer | | | | |
| Example 6 | Dual- | Upper | 25 | First lithium | 163 | Large |
| | Layer | layer | | transition metal | | |
| | | | | oxide (NCM 613 | | |
| | | | | single | | |
| | | | | particle):second | | |
| | | | | lithium transition | | |
| | | | | metal oxide | | |
| | | | | (NCM 9½½ | | |
| | | | | secondary | | |
| | | | | particle) = 25:75 | | |
| | | Lower | 75 | LMFP | | |
| | | layer | | | | |
| Example 7 | Dual- | Upper | 75 | First lithium | 177 | Large |
| | Layer | layer | | transition metal | | |
| | | | | oxide (NCM 613 | | |
| | | | | single | | |
| | | | | particle):second | | |
| | | | | lithium transition | | |
| | | | | metal oxide | | |
| | | | | (NCM 622 | | |
| | | | | secondary | | |
| | | | | particle) = 25:75 | | |
| | | Lower | 25 | LMFP | | |
| | | layer | | | | |
| Compar- | Dual- | Upper | 25 | First lithium | 159 | Small |
| ative | Layer | layer | | transition metal | | |
| Example 1 | | | | oxide | | |
| | | | | (NCM 613 | | |
| | | | | single | | |
| | | | | particle) | | |
| | | Lower | 75 | LMFP | | |
| | | layer | | | | |
| Compar- | Dual- | Upper | 25 | Second lithium | 161 | Large |
| ative | Layer | layer | | transition metal | | |
| Example 2 | | | | oxide (NCM 622 | | |
| | | | | secondary | | |
| | | | | particle) | | |
| | | Lower | 75 | LMFP | | |
| | | layer | | | | |

Referring to Table 1, it can be seen that the battery according to Comparative Example 1 exhibits a relatively lower capacity than those of Examples 1 to 7, and the battery according to Comparative Example 2 exhibits a relatively greater amount of gas generation after storage at 60° C. than those of Examples 1 to 5 and a relatively lower capacity than those of Examples 6 and 7.

Meanwhile, referring to Examples 1 to 7 in Table 1, it can be seen that the batteries according to Examples 3 and 4 exhibit inferior capacities compared with those of Examples 1 and 2, and the batteries according to Examples 5 to 7 exhibit a relatively greater amount of gas generation after storage at 60° C. compared with those of Examples 1 and 2. In contrast, it can be seen that the batteries according to Examples 1 and 2 exhibit relatively low gas generation after storage at 60° C. while maintaining high capacities.

As set forth above, according to an embodiment of the present disclosure, the safety of the cathode for a lithium secondary battery may be improved.

According to another embodiment of the present disclosure, a cathode for a lithium secondary battery having high energy density may be provided.

According to another embodiment of the present disclosure, a cathode for a lithium secondary battery having excellent cycle performance may be provided.

Only specific examples of implementations of certain embodiments are described. Variations, improvements and enhancements of the disclosed embodiments and other embodiments may be made based on the disclosure of this patent document.

What is claimed is:

1. A cathode for a lithium secondary battery, comprising:
a cathode current collector; and
a cathode mixture layer formed on at least one surface of the cathode current collector,
wherein the cathode mixture layer includes a first cathode mixture layer formed on the cathode current collector and a second cathode mixture layer formed on the first cathode mixture layer,
the first cathode mixture layer includes a lithium metal phosphate, and
the second cathode mixture layer includes a first lithium transition metal oxide, having a single particle form, and a second lithium transition metal oxide, having a secondary particle structure.

2. The cathode of claim 1, wherein the lithium metal phosphate includes a lithium manganese iron phosphate (LMFP)-based active material represented by the chemical formula LiMnₓFe₁₋ₓPO₄ (0<x<1).

3. The cathode of claim 1, wherein a weight of the second lithium transition metal oxide included in the second cathode mixture layer is equal to or greater than a weight of the first lithium transition metal oxide included in the second cathode mixture layer.

4. The cathode of claim 3, wherein a weight ratio of the first lithium transition metal oxide to the second lithium transition metal oxide included in the second cathode mixture layer is 50:50 to 20:80.

5. The cathode of claim 1, wherein an average particle diameter (D50) of the first lithium transition metal oxide is 2.5 to 5 μm.

6. The cathode of claim 1, wherein an average particle diameter (D50) of the second lithium transition metal oxide is 2.5 to 13.5 μm.

7. The cathode of claim 1, wherein the first lithium transition metal oxide includes nickel (Ni), and
a content of nickel (Ni) is 50 to 70 mol % based on a total content of transition metals included in the first lithium transition metal oxide.

8. The cathode of claim 1, wherein the second lithium transition metal oxide includes nickel (Ni), and
a content of nickel (Ni) is 50 to 70 mol % based on a total content of transition metals included in the second lithium transition metal oxide.

9. The cathode of claim 1, wherein a loading weight of the first cathode mixture layer is equal to or greater than a loading weight of the second cathode mixture layer.

10. The cathode of claim 9, wherein a loading weight ratio of the first cathode mixture layer to the second cathode mixture layer is 50:50 to 90:10.

11. A lithium secondary battery comprising the cathode for a lithium secondary battery of claim 1.
